(19) United States
(12) Patent Application Publication
(10) Pub. No.: US 2005/0152297 A1
(43) Pub. Date: Jul. 14, 2005

(54) Method and system for providing broadcast service in a wireless communication system, and access terminal therefor

(75) Inventor: Jong-Won Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/017,749

(22) Filed: Dec. 22, 2004

(30) Foreign Application Priority Data
Dec. 22, 2003 (KR) 2003-94756

(51) Int. Cl. H04J 3/24

(52) U.S. Cl. 370/312

(57) ABSTRACT

A mobile communication system and method for providing a broadcast service to at least one access terminal connected to a broadcast server providing the broadcast service. In the system and method, an access network changes a physical channel allocated to a plurality of broadcast channels at least once, provides the broadcast service to the access terminal using the changed physical channel, and transmits change information of the physical channel to an access terminal that transmitted a predetermined registration message if the registration message is received from the access terminal. The access terminal transmits the registration message to the access network, receives the change information of the physical channel in response, and receives data of a desired broadcast channel through the changed physical channel.

### PRIORITY

This application claims the benefit of 35 U.S.C. § 119(a) to an application entitled “Method and System for Providing Broadcast Service in a Wireless Communication System, and Access Terminal Therefor” filed in the Korean Intellectual Property Office on Dec. 22, 2003 and assigned Serial No. 2003-94756, the entire contents of which are incorporated herein by reference.

### BACKGROUND OF THE INVENTION

1. Field of the Invention

The present invention relates generally to a system and method for providing a packet service in a Code Division Multiple Access (CDMA) mobile communication system. In particular, the present invention relates to a mobile communication system and method for providing a broadcast service to a registered user, and an access terminal for receiving the broadcast service.

2. Description of the Related Art

A conventional Code Division Multiple Access (CDMA) mobile communication system provides a conventional voice call service or a short message service (SMS) through an access terminal such as a cellular phone or a Personal Communication System (PCS) phone. However, with advances in mobile communication technology, the latest CDMA mobile communication system can provide not only voice service but also a packet data service capable of transmitting data to an access terminal using an Internet protocol (IP).

In a CDMA mobile communication system supporting the packet data service, such data as voice, text and still image received from a wireless communication network is provided to an IP network like the Internet by an IP packet with a destination IP address, and an access terminal having the destination IP address receives the corresponding packet data and provides the received packet data to its user.

A CDMA mobile communication system in which research is currently being performed regarding packet data service, includes an Evolution Data-Only (EV-DO) system providing only data transmission, proposed by Qualcomm Incorporated, USA, an Evolution of Data and Voice (EV-DV) system provided to solve the shortcoming of the EV-DO system not being able to simultaneously support a voice service and a data service, and an International Mobile Telecommunication 2000 (IMT-2000) system, a next generation mobile communication system in which a voice service and a data service can be transmitted and received regardless of time and place.

Active research on the EV-DO, EV-DV, and IMT-2000 systems are being made to provide not only voice service but also a high-quality broadcast service that requires transmission of a large volume of broadcast data such as movie and news, through an access terminal.

In a conventional CDMA mobile communication system, because data communication with an access terminal allocated a unique IP address is achieved on a unicast basis for packet data transmission, broadcast data for the broadcast service is also transmitted on a unicast basis. When a characteristic of the broadcast service in which wideband broadcast data should be simultaneously transmitted to a plurality of access terminals at high speed is taken into consideration, the unicast is inefficient in that it wastes communication resources and increases a system load on the mobile communication system. Therefore, research is being conducted on technology for providing a high-quality broadcast service with reduced communication resources.

As a result of the research, a broadcast scheme for unidirectionally transmitting forward broadcast data through a single link at high speed without reverse feedback information from a plurality of access terminal has been proposed. According to this scheme, it is possible to provide a broadcast service to a plurality of users with reduced communication resources. This scheme is similar in concept to the over-the-air television broadcasting service.

If the broadcast service is provided on a noncommercial basis, unspecified access terminals can simply access a downlink traffic channel from an access network to access terminals. However, if the broadcast service is provided on a commercial basis, it is necessary to provide broadcast data only to registered access terminals of paying users, and not to access terminals which are not registered in the broadcasting system as authorized users.

To this end, it is necessary to transmit broadcast data through a single link and receive the broadcast data only through the access terminals that are registered as authorized users.

### SUMMARY OF THE INVENTION

It is, therefore, an object of the present invention to provide a mobile communication system and method for providing a broadcast service only to the access terminals registered as authorized users.

It is another object of the present invention to provide a method for transmitting broadcast data only to the access terminals registered as authorized users.

It is further another object of the present invention to provide a method for receiving broadcast data transmitted from the mobile communication system.

It is yet another object of the present invention to provide an access terminal for receiving broadcast data transmitted from the mobile communication system.

According to a first aspect of the present invention, there is provided a mobile communication system for providing a broadcast service to at least one access terminal connected to a broadcast server providing the broadcast service. The system comprises an access network for changing a physical channel allocated to a plurality of broadcast channels at least once, providing the broadcast service to the access terminal using the changed physical channel, and transmitting change information of the physical channel to an access terminal that transmitted a predetermined registration message if the registration message is received from the access terminal; and the access terminal for transmitting the registration message to the access network, receiving the change information of the physical channel in response, and receiving data of a desired broadcast channel through the changed physical channel.

According to a second aspect of the present invention, there is provided a method for transmitting broadcast data to at least one access terminal connected to a broadcast server via an access network. The method comprises the steps of transmitting, by the access network, information on a physical channel over which the broadcast data is transmitted, to the access terminal; transmitting, by the access terminal, a predetermined registration message for a broadcast service to the access network; transmitting, by the access network, change information of the physical channel to the access terminal; and transmitting, by the access network, the broadcast data over a physical channel changed according to the change information of the physical channel.

According to a third aspect of the present invention, there is provided a method for receiving broadcast data by at least one access terminal connected to a broadcast server via an access network. The method comprises the steps of receiving information on a physical channel over which the broadcast data is transmitted from the access network; transmitting a predetermined registration message for a broadcast service to the access network; receiving change information of the physical channel form the access network; and receiving the broadcast data transmitted over a physical channel changed according to the change information of the physical channel.

According to a fourth aspect of the present invention, there is provided an access terminal for receiving a broadcast service via a mobile communication system connected to a broadcast server. The access terminal comprises a communication module for exchanging packet data with the communication system via a wireless network; a memory for storing a basic operating program of the access terminal, and physical channel information for broadcast channels, received from the mobile communication system; and a controller connected between the communication module and the memory, for controlling the entire operation of the access terminal, transmitting a predetermined registration message to the mobile communication system at stated periods during a broadcast service, and changing the physical channel over which broadcast data is received by controlling an operation of the communication module if change information of the physical channel over which the broadcast data is transmitted from the mobile communication system is received.

According to the foregoing structure, after a user transmits a registration message for a broadcast service to a mobile communication system, only an access terminal that transmitted the registration message frequently receives change information of a physical channel over which broadcast data is transmitted. Therefore, only an access terminal registered in the mobile communication system as an authorized user can receive the broadcast service.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a configuration of a mobile communication system for providing a broadcast service according to an embodiment of the present invention;

FIG. 2 is a flow diagram illustrating a method for providing a broadcast service according to an embodiment of the present invention;

FIGS. 3A and 3B are diagrams illustrating a process of changing a physical channel for broadcast channels based on channel hopping information according to an embodiment of the present invention;

FIG. 4 is a flow diagram illustrating an operation performed after setup of a broadcast data bearer path according to an embodiment of the present invention;

FIG. 5 is a diagram illustrating an operation of receiving broadcast data by a plurality of access terminals that transmitted registration messages at different points, according to an embodiment of the present invention; and

FIG. 6 is a block diagram illustrating a structure of the access terminal shown in FIG. 1.

### DETAILED DESCRIPTION OF THE PREFERRED EMBODIMENT

An embodiment of the present invention will now be described in detail with reference to the accompanying drawings. In the following description, a detailed description of known functions and configurations incorporated herein has been omitted for conciseness.

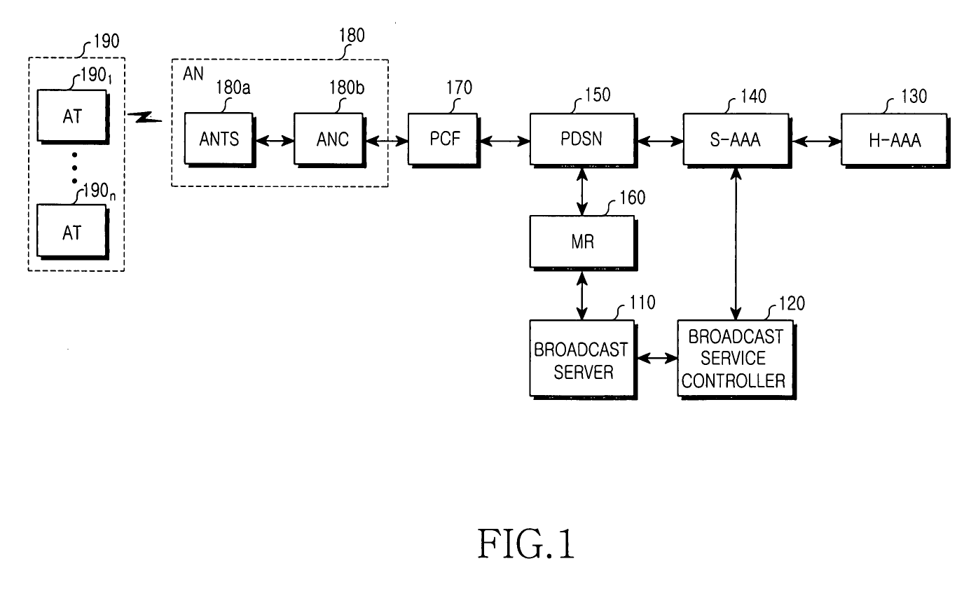

FIG. 1 is a block diagram illustrating a configuration of a mobile communication system for providing a broadcast service according to an embodiment of the present invention, wherein at least one access terminal (AT) 190 (190₁-190ₙ) receiving various broadcast data provided from a broadcast server 110 is connected to a Code Division Multiple Access (CDMA) wireless network. Although each element except the access terminal 190 is illustrated as a single element in FIG. 1 for simplicity, it can also be a multiple element according to a configuration of the CDMA network. In addition, although the embodiment of the present invention will be applied to a CDMA network in the following description, it can also be applied to other wireless networks supporting a packet data service.

In FIG. 1, a broadcast server 110 stores broadcast data including various image and/or voice data, and broadcast data output from the broadcast server 110 is transmitted to a packet data service node (PDSN) 150 under the control of a broadcast service controller 120. If the broadcast server 110 is connected to the packet data service node 150 via a packet communication network like the Internet, the broadcast data is created as compressed IP packet data.

The broadcast service controller 120, upon receiving a broadcast service request from the access terminal 190, receives user profile information from a home-authentication, authorization and accounting (H-AAA) sever 130, performs user authentication on the access terminal 190 using the user profile information, and transmits security parameter and session information to the access terminal 190 according to the user authentication result, thereby providing broadcast service information.

Although user authentication on the access terminal 190 is performed through the broadcast service controller 120 in this embodiment, the user authentication can also be performed by the packet data service node 150.

The packet data service node 150, connected to the access terminal 190 on a point-to-point protocol (PPP) basis, performs packet communication with the access terminal 190 and forms a multicast group of registered access terminals 190 receiving IP packet data (i.e., broadcast data) from the broadcast server 110. A multicast router (MR) 160, connected to the packet data service node 150, performs routing on IP addresses to which the multicast group belongs.

Although not illustrated in FIG. 1, the packet data service node 150 is connected to a known domain name system (DNS) that manages IP information and provides an IP address from the broadcast service controller 120 to a PPP-connected access terminal 190.

Broadcast data output from the broadcast server 110 is broadcast to a plurality of packet data service nodes 150 forming the multicast group, or unicasted to each packet data service node 150. Transmission of broadcast data from the packet data service node 150 to an access network (AN) 180 connected to a packet control function (PCF) 170 is achieved using general First Evolution-Data Only (1xEV-DO) network technology. The access network 180 comprises an access network transceiver subsystem (ANTS) 180a and an access network controller (ANC) 180b, both of which are well known in the field of mobile communication technology.

The access network 180 converts IP packet data (such as broadcast data) transmitted from the packet data service node 150 into a radio frequency (RF) signal, and transmits the RF signal to a plurality of access terminals 190 belonging to a service area where a soft combine is provided. The term “soft combine” refers to transmitting the same packet data in a specified service area for the same time and time slot.

The access network 180 transmits an overhead message to an access terminal 190 receiving the broadcast service periodically or aperiodically, the overhead message including information indicating availability of a current broadcast channel and information on a radio channel (such as physical channel) over which an RF signal converted from broadcast data is transmitted.

In the embodiment of the present invention, the access network 180 receives a registration message including a desired broadcast channel ID from an access terminal 190 that received the overhead message, and periodically or aperiodically transmits change information of a physical channel over which broadcast data is transmitted, to an access terminal 190 that transmitted the registration message. Here, the change information of a physical channel is transmitted to the access terminal 190 through a channel hopping information message which will be described below.

The access network 180 allows the physical channel to hop at a corresponding time based on physical channel information for each broadcast channel (logical channel), included in the overhead message, and change information of the physical channel, included in the channel hopping information message, and then transmits broadcast data over the changed channel.

In the embodiment of the present invention, the change information of the physical channel will be referred to as “channel hopping information.” The channel hopping information is included in a control channel located at the head of a traffic channel for broadcast data, and includes information on a period or action time at which the physical channel is changed.

The channel hopping information message is transmitted only to the access terminal 190 that transmitted the registration message, on a unicast basis. Therefore, it is not possible to transmit the channel hopping information to an access terminal that did not transmit the registration message or stopped transmitting the registration message, using a method of fraudulently modifying access terminals. As a result, unregistered access terminals cannot receive the broadcast service.

The access network 180 sends a setup request for a bearer path over which broadcast data is transmitted to an S-AAA server 140 that performs user accounting. The bearer path is established between an access terminal 190 that transmitted a first registration message and the packet data service node 150, for a corresponding broadcast channel, and when the bearer path is established, another access terminal 190 to which the same soft combine is provided, receives broadcast data over a previously established bearer path.

In the embodiment of the present invention, a subject of changing the physical channel based on the channel hopping information manages an active set, and the subject can be one of the access network transceiver subsystem (ANTS) 180a or the access network controller (ANC) 180b of the access network 180 or the packet control function 170 according to coverage of a service area where the soft combine is provided. Therefore, the channel hopping information is created from one of the access network transceiver subsystem 180a, the access network controller 180b and the packet control function 170 according to the subject that provides the soft combine, and then transmitted to the access terminal 190.

Generally, the access network 180, as illustrated in FIG. 1, includes the access network transceiver subsystem 180a and the access network controller 180b. In the following description, it will be assumed that the access network 180 includes even the packet control function 170 taking the soft combine into consideration.

Table 1 illustrates a format of the channel hopping information message created by the access network 180.

TABLE 1

| Field | Comment |
|---|---|
| Message ID | ID for message identification |
| Action Time | Action time (or period) at which physical channel over |
| | which broadcast data is transmitted is changed by hopping |
| Hopping | Hopping information of physical channel |
| information | |

Transmission/reception of the registration message and the channel hopping information message between the access terminal 190 and the access network 180 is performed periodically or aperiodically even after the bearer path is established.

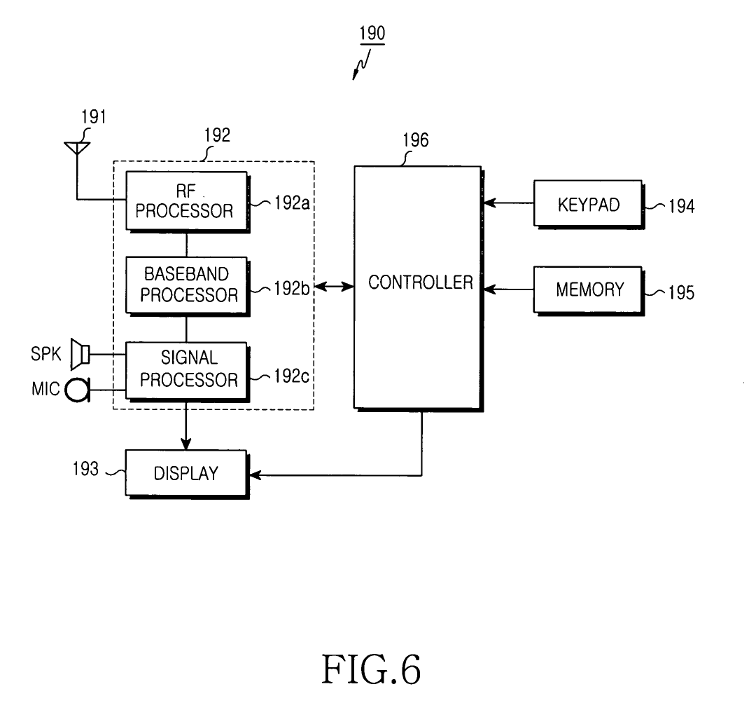

The access terminal 190 includes a predetermined operation program adapted to create the registration message according to a conventional communication module for transmitting/receiving various data via a wireless network and a set communication environment and transmit the created registration message to the access network 180, and to receive the physical channel information and the channel hopping information from the access network 180 and change a reception channel of broadcast data transmitted for the corresponding active time. An internal structure of the access terminal 190 will be described in detail below with reference to FIG. 6.

In sum, the broadcasting system of FIG. 1 periodically or aperiodically transmits the channel hopping information to an access terminal 190 that periodically transmitted a registration message after the bearer path is established between the access terminal 190 and the packet data service node 150, and frequently changes a physical channel over which actual broadcast data is transmitted, according to the channel hopping information. Therefore, only the access terminal 190 that transmitted the registration message can receive broadcast data transmitted over a changed channel.

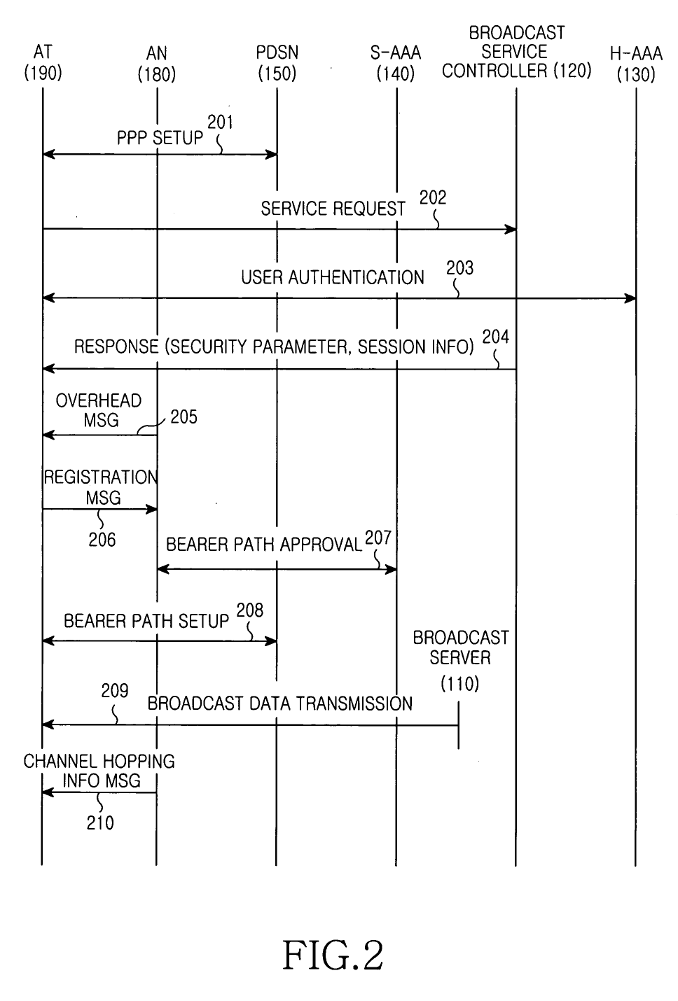

With reference to FIG. 2, a description will now be made of a method for transmitting broadcast data in the above-described broadcasting system according to an embodiment of the present invention.

Although not illustrated in FIG. 2, a broadcast service announcement including a broadcast channel list and a broadcast time provided from a mobile communication network operator or a broadcast service provider is provided to an access terminal 190 via an access network 180 on a broadcast basis. Alternatively, a user can receive the broadcast service announcement after accessing a wireless Internet service by key-manipulating the access terminal 190.

In step 201, if a user receiving a broadcast service announcement in the foregoing process selects a desired broadcast channel by key-manipulating an access terminal 190 of FIG. 1, the access terminal 190 sets up a PPP connection to a packet data service node 150 by transmitting a predetermined connection message for PPP connection to an access network 180. In step 202, the access terminal 190 receives an IP address of a broadcast service controller 120 from a DNS server (not shown), and then transmits a predetermined service request message for the broadcast channel selected in step 201 to the broadcast service controller 120.

In step 203, the broadcast service controller 120 requests and receives user profile information for the corresponding access terminal 190 from an H-AAA server 130, and performs user authentication using the received user profile information. If the user authentication is successful, the broadcast service controller 120 transmits, in step 204, security parameter and session information necessary for reception of broadcast data to the access terminal 190. For example, the security parameter includes a broadcast access key (BAK) for decryption of encrypted broadcast data and a lifetime of the broadcast access key, and the session information includes IP information and port information for reception of broadcast data.

In step 205, the access network 180 transmits an overhead message to the access terminal 190, the overhead message including physical channel information for at least one broadcast channel currently in service and availability information for respective broadcast channels. The access terminal 190 sets an air parameter for reception of broadcast data using the overhead message and a channel hopping information message received later.

In step 206, the access terminal 190 receiving the overhead message transmits a registration message to the access network 180, the registration message includes an ID of a broadcast channel selected by the user. Thereafter, in steps 207 to 209, a bearer path for transmission of broadcast data is established, and for a transmission broadcast channel, the access terminal 190 combines the overhead message received in step 206 from the access network 180 with a channel hopping information message received in step 210 from the access network 180, and receives a broadcast service according to information on a changed physical channel.

That is, in step 210, the access network 180 transmits a channel hopping information message to an access terminal 190 that transmitted the registration message, on a unicast basis, the channel hopping information message including physical channel information which is changed, for example, every action time. Although the channel hopping information message is periodically transmitted in this embodiment, it can also be aperiodically transmitted repeatedly.

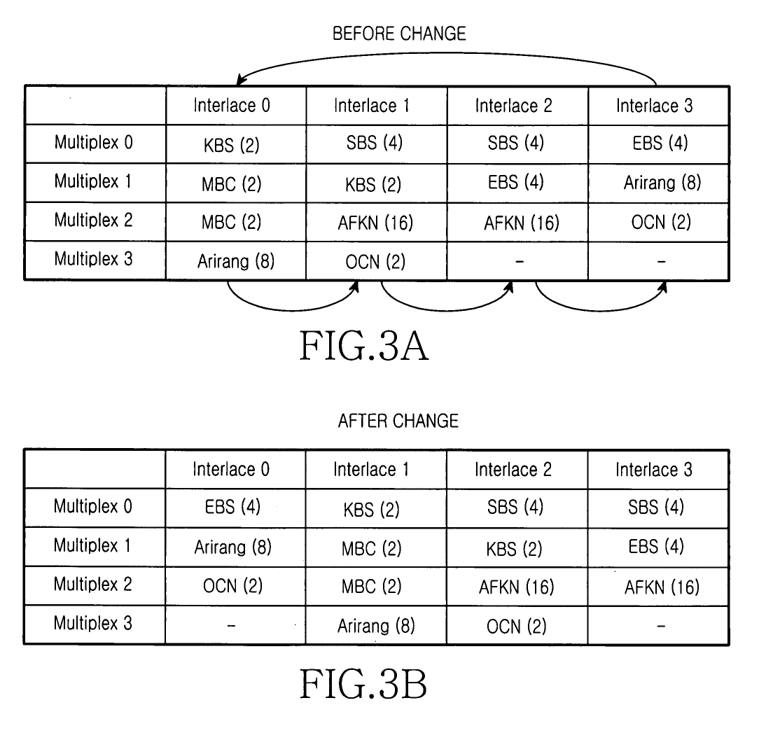

FIGS. 3A and 3B are diagrams for describing the channel hopping information according to an embodiment of the present invention. Specifically, FIG. 3A illustrates before-change physical channel information of broadcast channels, and FIG. 3B illustrates physical channel information changed according to the channel hopping information, wherein hopping information in the channel hopping information is 1.

In FIG. 3, the radio channel information is allocated Interlace, Multiplex and Burstlength. The Interlace refers to a slot of a physical channel transmitted on a per-time slot basis in a 1xEV-DO network, and the Multiplex refers to an index obtained by logically dividing the Interlace. In addition, the Burstlength refers to the number of repeated transmissions of a logical broadcast channel comprising the Interlace and the Multiplex.

In the embodiment of the present invention, channel hopping is achieved in a manner of basically fixing the Multiplex and the Burstlength and then shifting the Interlace based on the hopping information as illustrated in FIGS. 3A and 3B. Although only the Interlace is shifted in FIG. 3 by way of example, information on a radio channel can also be changed by shifting at least one of the interlace, the Multiplex and the Burstlength.

Therefore, the access terminal 190 can detect an actual physical channel (radio channel) which is changed every action time by comparing the before-change physical channel information included in the overhead message with the channel hopping information, and an access terminal 190 that did not transmit the registration message from the beginning or did not periodically transmit the registration message during a broadcast service, cannot use the broadcast service.

Here, the setup of the bearer path is made only for an access terminal 190 that first receives the broadcast data, and after the setup of the bearer path, only an operation of periodically or aperiodically receiving a channel hopping information message to receive broadcast data after transmitting the registration message is performed on all access terminals 190 located in the same service area.

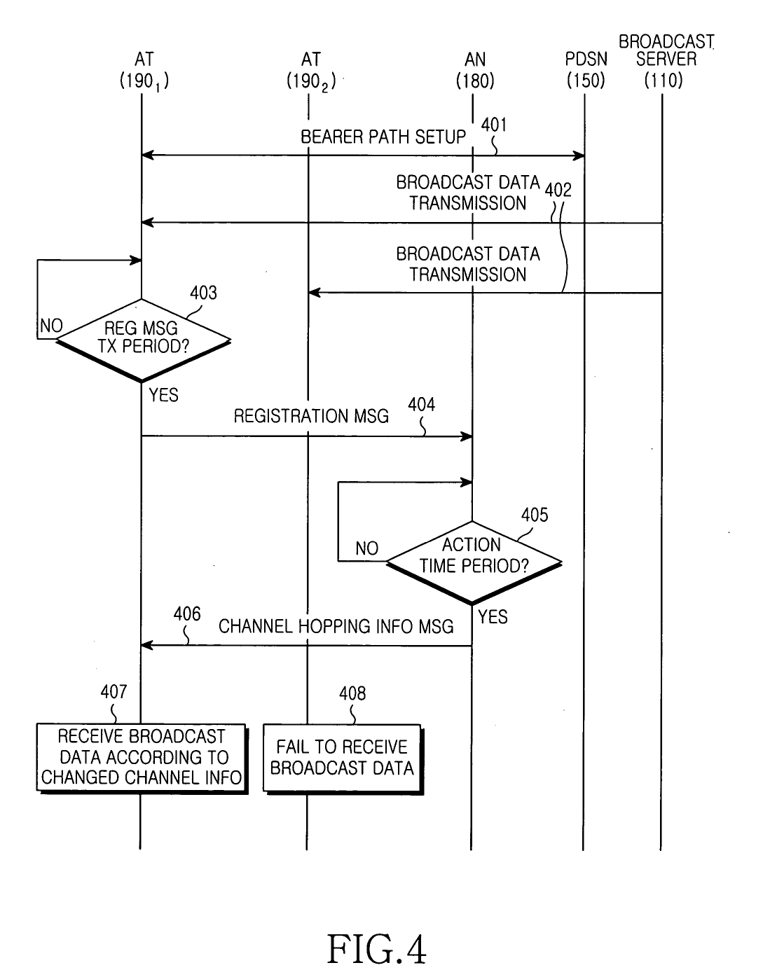

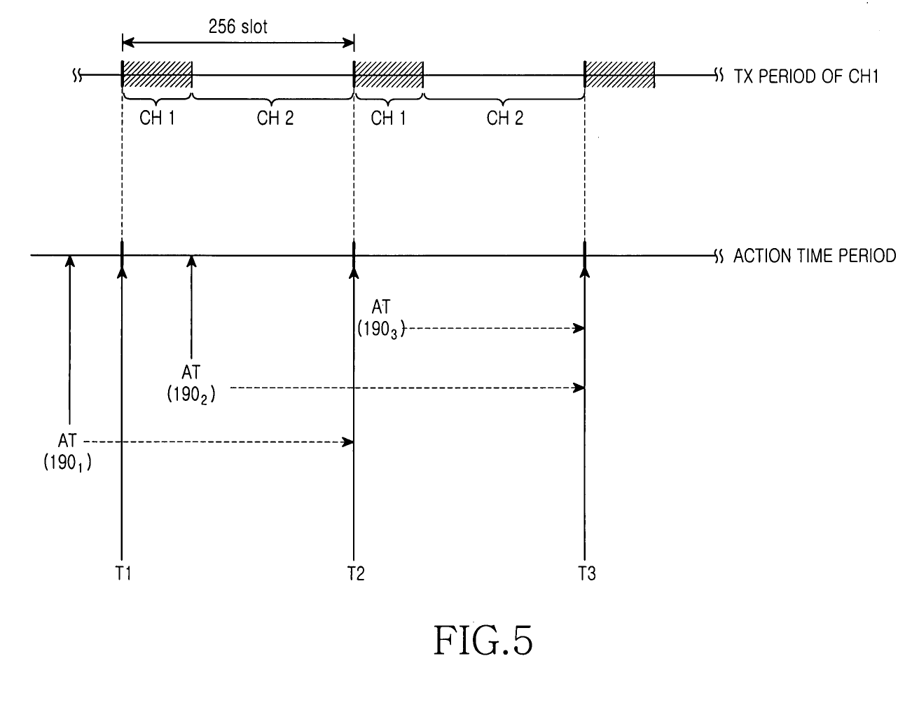

With reference to FIGS. 4 and 5, a detailed description will now be made of a method for transmitting broadcast data according to an embodiment of the present invention.

FIG. 4 is a flow diagram illustrating an operation in accordance with an embodiment of the present invention performed when an access terminal 190₁ registered by transmitting a registration message to the access network 180 and an access terminal 190₂ that did not transmit a registration message, want to use a broadcast service in a service area where the same soft combine is provided. In the following description, it will be assumed that a channel hopping information message is periodically transmitted.

In step 401, a bearer path for a registered access terminal 190₁ is established in the method performed in steps 207 and 208 of FIG. 2. In step 402, if broadcast data for the registered access terminal 190₁ is being transmitted, a second access terminal 190₂ entering a service area where the same soft combine is provided can use the same bearer path as that of the registered access terminal 190₁ even without performing steps 207 and 208 of FIG. 2.

In steps 403 and 404, the registered access terminal 190₁ checks whether a registration message transmission period previously set during an access to a broadcast service has arrived, and transmits the registration message to an access network 180 at each arrival of the transmission period. In steps 405 and 406, the access network 180 receiving the registration message checks whether a predetermined action time period has arrived, and transmits the channel hopping information message to the registered access terminal 190₁ on a unicast basis at each arrive of the active time period.

In step 407, the registered access terminal 190₁ compares the physical channel information extracted from the overhead message that was received in step 205 of FIG. 2 or will be periodically received afterward with the channel hopping information received in step 406, and then receives broadcast data for the next action time according to the changed channel information. However, in step 408, the other access terminal 190₂ that transmitted no registration message to the access network 180 cannot receive the channel hopping information transmitted by the access network 180 in step 406, and thus, cannot receive broadcast data transmitted from the access network 180 over a physical channel which is changed every action time or aperiodically.

With reference to FIG. 5, a description will now be made of broadcast data reception points of a plurality of access terminals that transmitted registration messages at different points. In FIG. 5, CH1 represents a control channel including the channel hopping information, and CH2 is a traffic channel carrying broadcast data. A physical channel includes both channels CH1 and CH2. An update period of the physical channel over which actual broadcast data is transmitted should be set such that it is sufficiently longer than a registration message transmission period of an access terminal 190.

This is to prevent the physical channel from being changed before the access terminal 190 transmits a registration message. In Broadcast/Multicast Service (BCMCS), because a general transmission period of a control channel CH1 corresponds to, for example, 256 time slots (=426.67 ms), the present invention sets the action times T1, T2, T3, . . . to a multiple of a period of the control channel CH1 to prevent the physical channel from being changed before channel hopping information is transmitted to the access terminal 190. FIG. 5 illustrates an example in which a transmission period of the control channel CH1 is matched to action times.

Further, FIG. 5 illustrates points where first to third access terminals 190₁, 190₂ and 190₃ can receive broadcast data for (1) the case where registration message transmission point of the first access terminal 190₁ is ahead of a first action time T1, (2) the case where the registration message transmission point of the second terminal 190₂ falls between the first action time T1 and a second action time T2, and (3) the case where the registration message transmission point of the second terminal 190₃ corresponds to the second action time T2. In the embodiment of the present invention, because the channel hopping information is applied to the next action time, the first access terminal 190₁ receives broadcast data from the second action time T2, and the second and third access terminals 190₂ and 190₃ receive broadcast data from the third action time T3.

With reference to FIG. 6, a detailed description will now be made of a method for receiving broadcast data and an access terminal 190 for receiving broadcast data according to an embodiment of the present invention.

FIG. 6 is a block diagram illustrating a structure of an access terminal 190 illustrated in FIG. 1. The access terminal 190 is made such that it changes a reception channel of broadcast data transmitted at a corresponding action time before reception, based on physical channel information included in the overhead message and channel hopping information included in the channel hopping information message.

In FIG. 6, a communication module 192 includes an RF processor 192a, connected to a wireless network via an antenna 191 under the control of a controller 196, for performing a modulation/demodulation process on a voice signal and packet data transmitted/received by the CDMA system, a baseband processor 192b for performing a coding/decoding process, and a signal processor 192c, connected to a microphone MIC, a speaker SPK and a liquid crystal display (LCD) display unit 193, for processing a voice signal and an image signal.

When a user selects a desired broadcast channel by manipulating a keypad 194, a memory 195 stores the security parameter and session information received from the broadcast service controller 120 of FIG. 1, and the physical channel information and channel hopping information received from the access network 180 of FIG. 1. As described above, the overhead message includes before-change physical channel information for the broadcast channels, and the channel hopping information includes hopping index and action time information for changing the physical channel information as illustrated in FIGS. 3A and 3B, and those are used for reception of broadcast data.

The controller 196 performs fundamental control required for voice or data communication and a broadcast service. In addition, during the broadcast service, the controller 196 transmits the registration message to the access network 180 of FIG. 1 at stated periods, receives physical channel information and channel hopping information from the access network 180, and controls an operation of the communication module 192 such that a physical channel accessing respective broadcast channels is changed.

In this structure, the access terminal 190 can detect a physical channel which is changed every action time by comparing the before-change physical channel information with the channel hopping information, and can simply receive broadcast data transmitted over the changed physical channel.

A detailed description will now be made of a process of receiving broadcast data by the access terminal 190 of FIG. 6.

If a predetermined broadcast service announcement is provided to the access terminal 190 from a mobile communication network operator or a broadcast service provider, or if a user manipulates the keypad 194 to receive a broadcast service after accessing a wireless Internet service and receiving the broadcast service announcement, the controller 196 of the access terminal 190 makes a PPP connection to the packet data service node 150, receives security parameter and session information necessary for a broadcast service from the broadcast service controller 120, and stores the received security parameter and session information in the memory 195, according to steps 201 to 204 of FIG. 2.

Thereafter, the controller 196 receives an overhead message from the access network 180, the overhead message including physical channel information for a broadcast channel currently in service and availability information of respective broadcast channels, stores the received overhead message in the memory 195, and then transmits a registration message including an ID of a broadcast channel selected by the user, to the access network 180. The access network 180 transmits a channel hopping information message to the corresponding access terminal 190 on a unicast basis, the channel hopping information message including channel hopping information which is changed every action time, and the controller 196 receiving the channel hopping information message sets an air parameter of the communication module 192 such that a physical channel for receiving broadcast data is changed based on the overhead message and the channel hopping information.

Thereafter, the controller 196 receives broadcast data transmitted over a bearer path established, in step 209 of FIG. 2, between the access network 180 and the packet data service node 150 using a physical channel designated for the corresponding action time. After the bearer path is established, transmission/reception of the registration message, overhead message and channel hopping information message in the corresponding service area is periodically or aperiodically repeated during an access to a broadcast service.

If broadcast data is received in the foregoing process, even though the physical channel over which the broadcast data is transmitted is frequently changed, the access terminal can simply receive broadcast data transmitted over the changed channel because after transmission of a registration message, the access terminal changes an air parameter of the communication module every action time using channel hopping information provided through the broadcasting system.

Therefore, an access terminal that transmitted no registration message to the access network cannot detect a changed physical channel for respective broadcast channels even though a bearer path has already been established through another access terminal 190. Thus, the corresponding access terminal cannot receive desired broadcast data.

As can be understood from the foregoing description, the embodiment of the present invention provides a broadcast service only to the access terminal registered as an authorized user by transmitting a registration message periodically. In addition, even after a bearer path for transmission of broadcast data is established, an access terminal should transmit a registration message in order for the frequently changed physical channel information to be transmitted to the access terminal. Therefore, it is possible to prevent an unauthorized user from receiving a broadcast service through fraudulent modification of the access terminal, and to provide a secure user authentication process to a broadcast service provider.

While the invention has been shown and described with reference to a certain embodiment thereof, it should be understood by those skilled in the art that various changes in form and details may be made therein without departing from the spirit and scope of the invention as defined by the appended claims.

1. A mobile communication system for providing a broadcast service to at least one access terminal connected to a broadcast server providing the broadcast service, the system comprising:
an access network for changing a physical channel allocated to a plurality of broadcast channels at least once, providing the broadcast service to the access terminal using the changed physical channel, and transmitting change information of the physical channel to an access terminal that transmitted a predetermined registration message if the registration message is received from the access terminal; and
the access terminal for transmitting the registration message to the access network, receiving the change information of the physical channel in response, and receiving data of a desired broadcast channel through the changed physical channel.

2. The mobile communication system of claim 1, wherein the registration message and the change information of the physical channel are transmitted/received at stated periods even after a broadcast data bearer path for the access terminal is established.

3. The mobile communication system of claim 1, wherein the change information of the physical channel are aperiodically transmitted/received at least once even after a broadcast data bearer path for the access terminal is established.

4. The mobile communication system of claim 1, wherein the change information of the physical channel includes channel hopping information including a predetermined action time representative of a time at which the physical channel is changed, and the access network changes the physical channel at the action time.

5. The mobile communication system of claim 1, wherein the change information of the physical channel is transmitted only to an access terminal that transmitted the registration message, on a unicast basis.

6. The mobile communication system of claim 1, wherein the access network includes an access network transceiver subsystem, an access network controller, and a packet control function, and the change information of the physical channel is created by one of the access network transceiver subsystem, the access network controller, and the packet control function.

7. A method for transmitting broadcast data to at least one access terminal connected to a broadcast server via an access network, the method comprising the steps of:
(a) transmitting, by the access network, information on a physical channel over which the broadcast data is transmitted, to the access terminal;
(b) transmitting, by the access terminal, a predetermined registration message for a broadcast service to the access network;
(c) transmitting, by the access network, change information of the physical channel to the access terminal; and
(d) transmitting, by the access network, the broadcast data over a physical channel changed according to the change information of the physical channel.

8. The method of claim 7, wherein the registration message and the change information of the physical channel are transmitted/received at stated periods even after a broadcast data bearer path for the access terminal is established.

9. The method of claim 7, wherein the change information of the physical channel are aperiodically transmitted/received at least once even after a broadcast data bearer path for the access terminal is established.

10. The method of claim 7, wherein the change information of the physical channel includes a predetermined action time representative of a time at which the physical channel is changed, and the step (d) is performed at the action time.

11. The method of claim 7, wherein the change information of the physical channel is transmitted to the access terminal through a predetermined channel hopping information message, and the channel hopping information message includes information on a message identifier, the action time, and hopping information of the physical channel.

12. The method of claim 11, wherein each radio channel over which the broadcast data is transmitted is allocated Interlace, Multiplex, and Burstlength, and the change of the physical channel is achieved by shifting at least one of the Interlace, the Multiplex, and the Burstlength based on the hopping information.

13. The method of claim 7, wherein an update period of the physical channel is set longer than a transmission period of the registration message.

14. The method of claim 7, wherein in the step (c), the change information of the physical channel is transmitted only to the access terminal that transmitted the registration message, on a unicast basis.

15. A method for receiving broadcast data by at least one access terminal connected to a broadcast server via an access network, the method comprising the steps of:
(a) receiving information on a physical channel over which the broadcast data is transmitted from the access network;
(b) transmitting a predetermined registration message for a broadcast service to the access network;
(c) receiving change information of the physical channel form the access network; and
(d) receiving the broadcast data transmitted over a physical channel changed according to the change information of the physical channel.

16. The method of claim 15, wherein the registration message and the change information of the physical channel are transmitted/received at stated periods even after a broadcast data bearer path for the access terminal is established.

17. The method of claim 15, wherein the change information of the physical channel are aperiodically transmitted/received at least once even after a broadcast data bearer path for the access terminal is established.

18. The method of claim 15, wherein the change information of the physical channel includes a predetermined action time indicative of a time at which the physical channel is transmitted, and the step (d) is performed at the action time.

19. The method of claim 18, wherein the change information of the physical channel is transmitted to the access terminal through a predetermined channel hopping information message, and the channel hopping information message includes information on a message identifier, the action time, and hopping information of the physical channel.

20. The method of claim 19, wherein each radio channel over which the broadcast data is transmitted is allocated Interlace, Multiplex, and Burstlength, and the change of the physical channel is achieved by shifting at least one of the Interlace, the Multiplex, and the Burstlength based on the hopping information.

21. The method of claim 15, wherein an update period of the physical channel is set longer than a transmission period of the registration message.

22. The method of claim 15, wherein in the step (c), the change information of the physical channel is transmitted only to the access terminal that transmitted the registration message, on a unicast basis.

23. An access terminal for receiving a broadcast service via a mobile communication system connected to a broadcast server, comprising:
a communication module for exchanging packet data with the communication system via a wireless network;
a memory for storing a basic operating program of the access terminal, and physical channel information for broadcast channels, received from the mobile communication system; and
a controller connected between the communication module and the memory, for controlling the entire operation of the access terminal, transmitting a predetermined registration message to the mobile communication system at stated periods during a broadcast service, and changing the physical channel over which broadcast data is received by controlling an operation of the communication module if change information of the physical channel over which the broadcast data is transmitted from the mobile communication system is received.

24. The access terminal of claim 23, wherein the change information of the physical channel includes a predetermined action time representative of a time at which the physical channel is changed, and the broadcast data is received at the action time.

25. The access terminal of claim 23, wherein the change information of the physical channel is transmitted to the access terminal through a predetermined channel hopping information message, and the channel hopping information message includes information on a message identifier, the active time, and hopping information of the physical channel.

26. The access terminal of claim 25, wherein each radio channel over which the broadcast data is transmitted is allocated Interlace, Multiplex, and Burstlength, and the controller sets an air parameter of the communication module such that at least one of the Interlace, the Multiplex, and the Burstlength is shifted based on the hopping information at the action time, if the channel hopping information message is received.
